(19) United States
(12) Patent Application Publication
(10) Pub. No.: US 2018/0162661 A1
(43) Pub. Date: Jun. 14, 2018

(54) IMAGE FORMATION APPARATUS

(71) Applicant: Konica Minolta, Inc., Tokyo (JP)

(72) Inventors: Katsumi KUROYANAGI, Toyokawa-shi (JP); Kouki MURAMOTO, Toyohashi-shi (JP); Katsumi KATOU, Toyokawa-shi (JP); Masashi KAWAI, Toyohashi-shi (JP); Kenichi YAMAMOTO, Toyokawa-shi (JP)

(73) Assignee: Konica Minolta, Inc., Tokyo (JP)

(21) Appl. No.: 15/826,902

(22) Filed: Nov. 30, 2017

(30) Foreign Application Priority Data
Dec. 14, 2016 (JP) 2016-241753

(51) Int. Cl. B65H 1/14; G03G 15/00; B65H 1/24; B65H 3/06; B65H 29/12

(52) U.S. Cl. CPC B65H 1/14; G03G 15/605; B65H 2801/06; B65H 3/06; B65H 29/12; B65H 1/24

(57) ABSTRACT

Provided is an image formation apparatus having a paper tray which is removably provided to an apparatus main body, in which sheets are loaded on a lifting plate, and from which the sheets on the lifting plate are fed by a paper feeding device, and the apparatus includes a holder that holds the lifting plate at a position higher than a lowest position when the paper tray is pulled out of the apparatus main body and the sheets are loaded on the lifting plate, wherein the holding by the holder is canceled to make the lifting plate go down to the lowest position before an operation of inserting the paper tray into the apparatus main body is completed.

The entire disclosure of Japanese patent Application No. 2016-241753, filed on Dec. 14, 2016, is incorporated herein by reference in its entirety.

### BACKGROUND

### Technological Field

The present invention relates to an image formation apparatus having a paper tray removably provided to an apparatus main body. Sheets are loaded on a lifting plate of the paper tray and will be fed by a paper feeding device. In such an apparatus, if the paper tray containing more than a specified number of sheets on the lifting plate is inserted into the main body of the image formation apparatus, the occurrence of an impact or the like will make the excess sheets go up on a width-direction restricting plate in the paper tray or go out of the paper tray. In this regard, the present invention is featured in that the proper paper feeding can be stably performed by preventing such problems easily.

### Description of the Related Art

The conventional image formation apparatus such as copiers, printers, fax machines, or multifunction machines transfer a toner image retained on a surface of an image retainer to a sheet supplied from a paper feeding device and then fixes the transferred unfixed toner image onto the sheet by a fixing device.

Here, in the paper feeding device in the image formation apparatus as above, the sheets are loaded on the lifting plate in the paper tray such as a paper cassette, and the sheets are fed and transported by a paper feeding roller such as a rubber roller from the top of the loaded sheets.

In the case of feeding and transporting the sheets loaded on the lifting plate in the paper tray in this manner by the paper feeding roller, transporting the sheets properly in the straight state requires that the sheets are fed in the proper state by the paper feeding roller.

In view of this, the width-direction restricting plate that restricts the position of the sheets in the width direction on the lifting plate in the paper tray or a rear-end restricting plate that restricts the position of a rear end of the sheets has conventionally been provided. In the state that the sheet posture is controlled with such a plate, the sheets loaded on the lifting plate in the paper tray are moved up to the position in contact with the paper feeding roller. At this position, the paper feeding roller feeds the sheets from the paper tray.

When the paper tray is inserted into the main body of the image formation apparatus with the sheets loaded on the lifting plate in the paper tray, it happens that the sheets loaded on the lifting plate in the paper tray go up on the width-direction restricting plate in the paper tray or go out of the paper tray. In order to prevent this, a label or a mark is provided to show the allowable maximum loading position at which the paper tray can contain the sheets properly at maximum.

Even in this case, however, some users set sheets on the lifting plate in the paper tray over the allowable maximum loading position. Thus, the problems still remain: when the paper tray is inserted into the main body of the image formation apparatus, the sheets loaded on the lifting plate in the paper tray go up on the width-direction restricting plate in the paper tray or go out of the paper tray to fail the proper paper feeding.

In view of the above, conventionally, JP 2015-110464 A has suggested that the width restricting extension member is provided at the upper part of the width-direction restricting plate and this width restricting extension member is moved up as the sheet bundle is lifted up.

According to JP 2015-110464 A, however, the mechanism to move up the width restricting extension member as the sheet bundle is lifted up is necessary. This results in the size increase of the width-direction restricting portion and the higher cost.

In another suggestion according to JP 2005-59980 A, the extension restricting member is provided to protrude to the upper surface side of the sheets loaded on an upper end of the width-direction restricting plate. This structure can prevent the sheets set in the paper tray, even if the sheet is curled, from going up on the width-direction restricting plate.

According to JP 2005-59980 A, however, the extension restricting member protrudes to the upper surface side of the sheet from the upper end of the width-direction restricting plate; therefore, the extension restricting member interrupts the work of loading the sheets on the lifting plate in the paper tray.

In another suggestion made in JP 2009-234690 A, the protrusion provided at the width-direction restricting plate to protrude to the upper surface side of the sheets is moved up and down as the paper tray is attached to or detached from the main body of the image formation apparatus.

According to JP 2009-234690 A, however, the protrusion protrudes to the upper surface side of the sheets; therefore, this protrusion interrupts the work of loading the sheets on the lifting plate in the paper tray.

### SUMMARY

The present invention is to solve the aforementioned problems in the image formation apparatus in which the paper tray containing sheets is removably provided to the apparatus main body and the sheets loaded in the paper tray are fed by the paper feeding device.

That is to say, it is an object of the present invention to provide an image formation apparatus in which, even in the case where the sheets are set on the lifting plate in the paper tray over the allowable maximum loading position to show the maximum level of the proper paper loading, when this paper tray is inserted into the main body of the image formation apparatus, it is possible to easily prevent the excess sheets from going up on the width-direction restricting plate in the paper tray or going out of the paper tray due to an impact or the like and the proper paper feeding can be performed stably.

To achieve the abovementioned object, according to an aspect of the present invention, there is provided an image formation apparatus having a paper tray which is removably provided to an apparatus main body, in which sheets are loaded on a lifting plate, and from which the sheets on the lifting plate are fed by a paper feeding device, and the apparatus reflecting one aspect of the present invention comprises a holder that holds the lifting plate at a position higher than a lowest position when the paper tray is pulled out of the apparatus main body and the sheets are loaded on the lifting plate, wherein the holding by the holder is canceled to make the lifting plate go down to the lowest position before an operation of inserting the paper tray into the apparatus main body is completed.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic explanatory view illustrating an example of an image formation apparatus according to an embodiment of the present invention;

FIG. 2 is a schematic perspective view of a paper tray used in the image formation apparatus according to the embodiment;

FIGS. 3A and 3B illustrate the state in which a lifting plate is held by a holding member at a position higher than the lowest position when the paper tray is pulled out of an apparatus main body and sheets are loaded on the lifting plate in a first example of the image formation apparatus according to the embodiment, and FIG. 3A is a partial cross-sectional explanatory view on a side surface side and FIG. 3B is a partial cross-sectional explanatory view on a planar surface side;

FIGS. 4A to 4C are partial cross-sectional explanatory views on a planar surface side where as the paper tray is guided into the apparatus main body, the holding member that holds the lifting plate at the position higher than the lowest position is rotated by a protrusion provided in the apparatus main body to detach the holding member from the lifting plate in the first example, and FIG. 4A illustrates the state in which the holding member is not rotated by the protrusion and the lifting plate is held by the holding member, FIG. 4B illustrates the state in which the lifting plate is held by the holding member in the middle of the rotation of the holding member by the protrusion, and FIG. 4C illustrates the state in which the holding member is rotated by the protrusion to detach the holding member from the lifting plate;

FIGS. 5A to 5C illustrate the first example, and FIG. 5A is a partial cross-sectional explanatory view on the side surface side illustrating the state in which the lifting plate is held by the holding member at the position higher than the lowest position and the sheets are loaded on the lifting plate over the allowable maximum loading position, FIG. 5B is a partial cross-sectional explanatory view on the side surface side illustrating the state in which the holding member is detached from the lifting plate to make the lifting plate and the sheets loaded on the lifting plate go down, and FIG. 5C is a partial cross-sectional explanatory view on the side surface side illustrating the state in which the lifting plate is rotated upward to bring the sheets loaded on the lifting plate in contact with a paper feeding roller and thus the paper feeding is performed;

FIGS. 6A to 6C illustrate the state in which the lifting plate is moved up and down by an elevating device and the stop position of the lifting plate is controlled by a control device in a second example of the image formation apparatus according to the embodiment, and FIG. 6A is a partial cross-sectional explanatory view on the side surface side illustrating the state in which the lifting plate is stopped at the position higher than the lowest position and the sheets are loaded on the lifting plate over the allowable maximum loading position, FIG. 6B is a partial cross-sectional explanatory view on the side surface side illustrating the state in which the lifting plate and the sheets on the lifting plate are moved down, and FIG. 6C is a partial cross-sectional explanatory view on the side surface side illustrating the state in which the lifting plate is moved up to bring the sheets loaded on the lifting plate in contact with the paper feeding roller and thus the paper feeding is performed;

FIGS. 7A and 7B illustrate a third example of the image formation apparatus according to the embodiment, and FIG. 7A is a partial cross-sectional explanatory view on the side surface side illustrating the state in which the lifting plate is held at the position higher than the lowest position and the sheets are set on the lifting plate over the allowable maximum loading position, and FIG. 7B is a partial cross-sectional explanatory view on the side surface side illustrating the state in which the lifting plate is moved to the lowest position to make the sheets set on the lifting plate come to the position lower than the allowable maximum loading position;

FIGS. 8A to 8D are partial perspective explanatory views illustrating the state in which when the paper tray is inserted into the apparatus main body, an adjustment member provided to the paper tray moves in the apparatus main body in the third example, and FIG. 8A illustrates the state before the adjustment member is guided to a lowering projection in the apparatus main body, FIG. 8B illustrates the state in which the adjustment member is guided below the lowering projection, FIG. 8C illustrates the state in which the adjustment member is guided to a position of a first pressing protrusion provided on the downstream side in the apparatus main body relative to the lowering projection, and FIG. 8D illustrates the state in which the adjustment member is guided to a position of a second pressing protrusion provided on the downstream side in the apparatus main body relative to the first pressing protrusion; and

FIGS. 9A to 9D are partial cross-sectional explanatory views illustrating the relation between the adjustment member and the lifting plate in accordance with the state in which the adjustment member provided to the paper tray is moved in the apparatus main body as illustrated in FIGS. 8A to 8D, and FIG. 9A illustrates the state before the adjustment member is guided to the lowering projection in the apparatus main body, FIG. 9B illustrates the state in which the adjustment member is guided below the lowering projection, FIG. 9C illustrates the state in which the adjustment member is guided to the position of the first pressing protrusion provided on the downstream side in the apparatus main body relative to the lowering projection, and FIG. 9D illustrates the state in which the adjustment member is guided to the position of the second pressing protrusion provided on the downstream side in the apparatus main body relative to the first pressing protrusion.

### DETAILED DESCRIPTION OF EMBODIMENTS

Hereinafter, an image formation apparatus according to one or more embodiments of the present invention will be specifically described with reference to the drawings. However, the image formation apparatus according to the present invention is not limited to the disclosed embodiments. Various changes can be made in the range not departing from the concept.

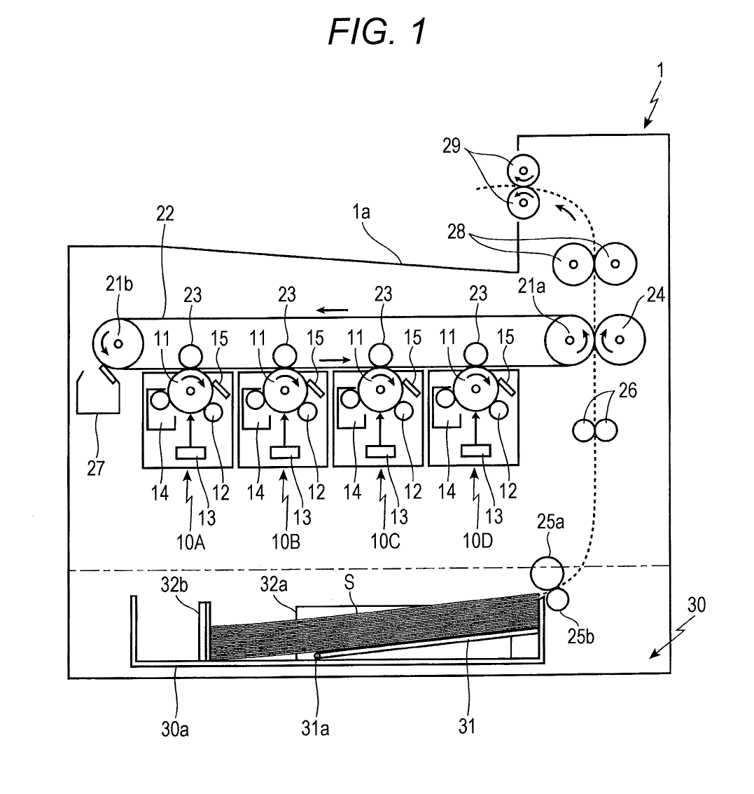

Here, the image formation apparatus according to the embodiment of the present invention has four imaging cartridges 10A to 10D inside an apparatus main body 1 as illustrated in FIG. 1.

Each of the imaging cartridges 10A to 10D includes a photoreceptor 11, a charging device 12 to charge a surface of the photoreceptor 11, a latent image formation device 13 that exposes the charged surface of the photoreceptor 11 to light in accordance with the image information to form an electrostatic latent image on the surface of the photoreceptor 11, a development device 14 that supplies toner to the electrostatic latent image formed on the surface of the photoreceptor 11 and forms a toner image, and a first cleaning device 15 that removes the toner, which remains after the toner image formed on the surface of the photoreceptor 11 is transferred to an intermediate transfer belt 22, from the surface of the photoreceptor 11.

The development devices 14 in the imaging cartridges 10A to 10D contain toner with different colors, specifically the black, yellow, magenta, and cyan colors.

In this image formation apparatus, the following processes are performed in each of the imaging cartridges 10A to 10D: a surface of each photoreceptor 11 is charged with the charging device 12; the charged surface of each photoreceptor 11 is exposed to light in accordance with the image information by the latent image formation device 13 to form an electrostatic latent image on the surface of each photoreceptor 11 in accordance with the image information; and the colored toner is supplied from each development device 14 to the electrostatic latent image formed on the surface of each photoreceptor 11. In this manner, the colored toner image is formed on the surface of each photoreceptor 11.

Next, the colored toner images formed on the surface of the photoreceptors 11 in the imaging cartridges 10A to 10D in this manner are sequentially transferred by primary transfer rollers 23 onto an intermediate transfer belt 22 that is stretched between, and rotated and driven by a driving roller 21a and a rotating roller 21b. Then, the toner images are synthesized on the intermediate transfer belt 22. The synthesized toner image formed in this manner is guided by the intermediate transfer belt 22 to a position opposite to a secondary transfer roller 24. Note that the toner, which remains on the surface of each photoreceptor 11 after the transfer, is removed from the surface of the photoreceptor 11 by the corresponding first cleaning device 15.

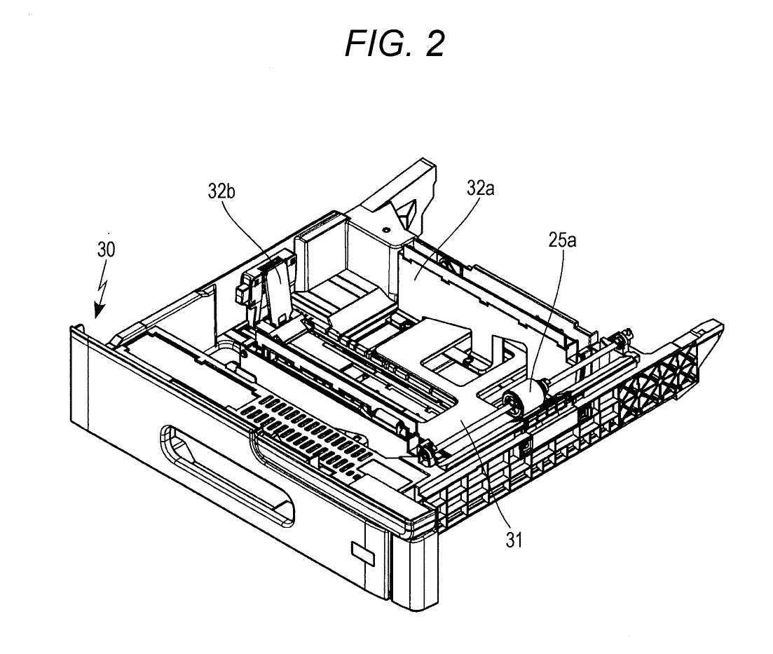

In this image formation apparatus, as illustrated in FIGS. 1 and 2, a paper tray 30 is removably provided to a lower part of the apparatus main body 1. A lifting plate 31 on which sheets S are loaded is provided on a bottom part 30a of the paper tray 30 in a manner that the lifting plate 31 can be rotated in a vertical direction by a rotatable member (not shown) such as a spring using a supporting shaft 31a as a fulcrum. In addition, a width-direction restricting plate 32a that restricts the position of the sheets S in a direction intersecting with the paper feeding direction of the sheets S loaded on the lifting plate 31, that is, in the width direction of the sheets S is provided to be movable in the width direction of the paper tray 30. Further, a rear-end position restricting plate 32b that restricts the position of a rear end of the sheets S on a side opposite to the paper feeding direction of the sheets S loaded on the lifting plate 31 is provided to be movable in the paper feeding direction of the paper tray 30.

In this embodiment, the width-direction restricting plate 32a and the rear-end position restricting plate 32b provided to the paper tray 30 are set at predetermined positions in accordance with the size of the sheets S loaded in the paper tray 30, and moreover the plurality of sheets S is loaded on the lifting plate 31. In this state, the lifting plate 31 is rotated upward using the supporting shaft 31a as a fulcrum, thereby bringing the sheet S on the lifting plate 31 in contact with a paper feeding roller 25a.

When the sheet S in contact is fed by the paper feeding roller 25a, it may happen that more than one sheet S is fed by the paper feeding roller 25a. In such a case, the sheets S are separated between the paper feeding roller 25a and a separating roller 25b that is provided opposite to the paper feeding roller 25a, so that the sheets S are fed one by one by the paper feeding roller 25a and the thusly fed one sheet S is guided to timing rollers 26.

The sheet S guided as above is next guided to pass between the intermediate transfer belt 22 and the secondary transfer roller 24 at an appropriate timing by the timing rollers 26, and then the toner image formed on the intermediate transfer belt 22 is transferred to the sheet S by the secondary transfer roller 24. Note that the remainder such as the toner that has not been removed by the transfer onto the sheet S but has been left on the intermediate transfer belt 22 is removed from the intermediate transfer belt 22 by a second cleaning device 27.

On the other hand, the sheet S on which the toner image has been transferred as above is guided to heating and fixing rollers 28. By the heating and fixing rollers 28, the unfixed toner image that is transferred to the sheet S is heated and fixed on the sheet S. Then, the sheet S with the toner image fixed thereon is discharged to a paper discharging unit 1a of the apparatus main body 1 by discharging rollers 29.

Next, a first example of the above embodiment will be described. In the first example, when the paper tray 30 is pulled out of the apparatus main body 1 and the sheets S are loaded on the lifting plate 31 in the paper tray 30, the lifting plate 31 is held by a holder at a position higher than the lowest position Hlow, and before the operation of inserting the paper tray 30 into the apparatus main body 1 is completed, the holding by the holder is canceled so that the lifting plate 31 goes down to the lowest position Hlow.

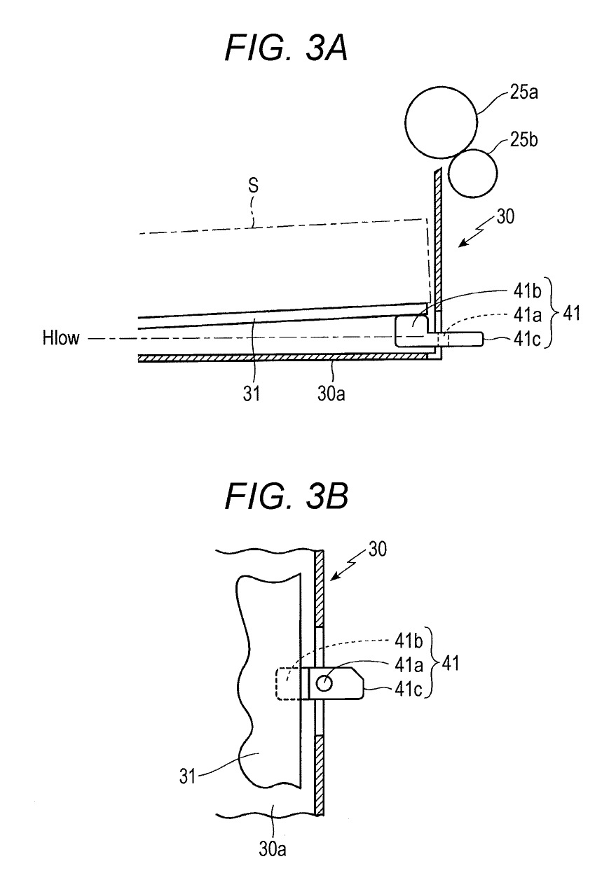

Here, in the first example, a holding member 41 is provided as the holder described above. As illustrated in FIGS. 3A and 3B, for example, the holding member 41 rotates in parallel to the bottom part 30a of the paper tray 30 around a shaft 41a in a lower part of the paper tray 30 on the paper feeding roller 25a side.

In the first example, the holding member 41 is rotated around the shaft 41a in a state of being energized by an energizing member (not shown) such as a spring. In a state that the paper tray 30 is pulled out of the apparatus main body 1, the holding member 41 is energized by the energizing member as illustrated in FIGS. 3A and 3B so that a holding portion 41b with large thickness in the holding member 41 comes to the position between the lifting plate 31 and the bottom part 30a of the paper tray 30. With this holding portion 41b, the lifting plate 31 is moved up and held at a position higher than the lowest position Hlow. On the lifting plate held at the position higher than the lowest position Hlow in this manner, the sheets S are loaded. On the other hand, the holding member 41 has an operation portion 41c with smaller thickness on a side opposite to the holding portion 41b with the shaft 41a interposed therebetween. The operation portion 41c protrudes from the paper tray 30 to a side opposite to the lifting plate 31.

In the first example, a protrusion 1b is provided as a canceller that cancels the holding of the lifting plate 31 by the holding portion 41b in the holding member 41 at the position higher than the lowest position Hlow when the sheets S are loaded on the lifting plate 31 held at the position higher than the lowest position Hlow and this paper tray 30 is guided into the apparatus main body 1. Specifically, the protrusion 1b is provided in the apparatus main body 1 on the paper feeding roller 25a side to face the paper tray 30 and protrudes to the paper tray 30 so as to collide with the operation portion 41c which is on the side opposite to the holding portion 41b and which protrudes from the paper tray 30 to the side opposite to the lifting plate 31.

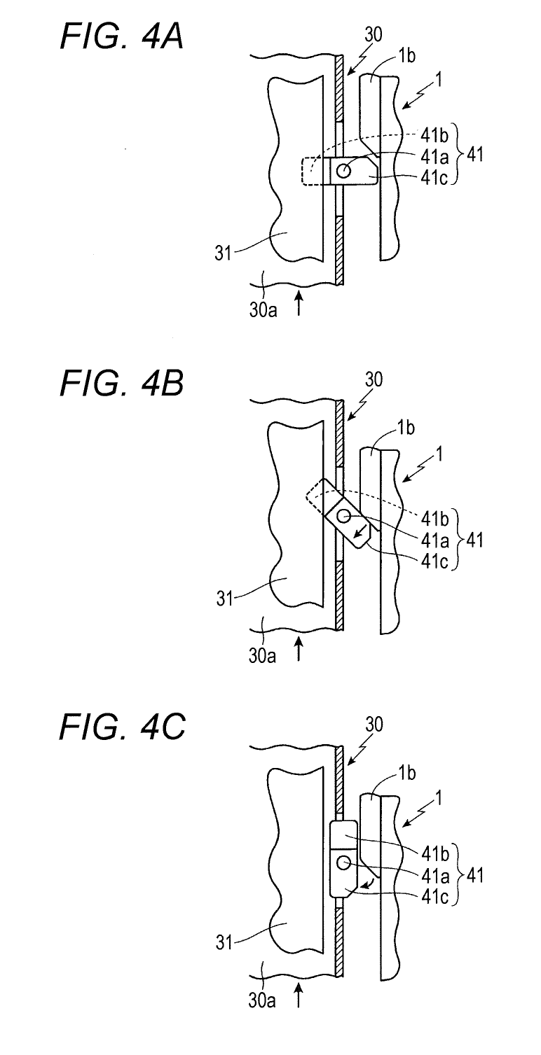

When the paper tray 30 is guided into the apparatus main body 1 in a state that the sheets S are loaded on the lifting plate 31 held at the position higher than the lowest position Hlow as above, as illustrated in FIG. 4A, the operation portion 41c protruding from the paper tray 30 to the side opposite to the lifting plate 31 on the side opposite to the holding portion 41b that holds the lifting plate 31 as above is guided to the position of the protrusion 1b that protrudes toward the paper tray 30 in the apparatus main body 1. Then, the operation portion 41c of the paper tray 30 is brought into contact with the protrusion 1b provided in the apparatus main body 1.

Guiding the paper tray 30 further into the apparatus main body 1 in this state causes the operation portion 41c of the paper tray 30 to be pushed in contact with the protrusion 1b in the apparatus main body 1 as illustrated in FIG. 4B. Then, the holding member 41 is rotated around the shaft 41a resisting against the energizing member, so that the holding portion 41b that holds the lifting plate 31 is rotated in a direction gradually away from below the lifting plate 31.

Further guiding the paper tray 30 into the apparatus main body 1 in this state causes the holding member 41 to be rotated further around the shaft 41a resisting against the energizing member. By this rotation, the holding portion 41b that holds the lifting plate 31 is guided to a position away from below the lifting plate 31 as illustrated in FIG. 4C.

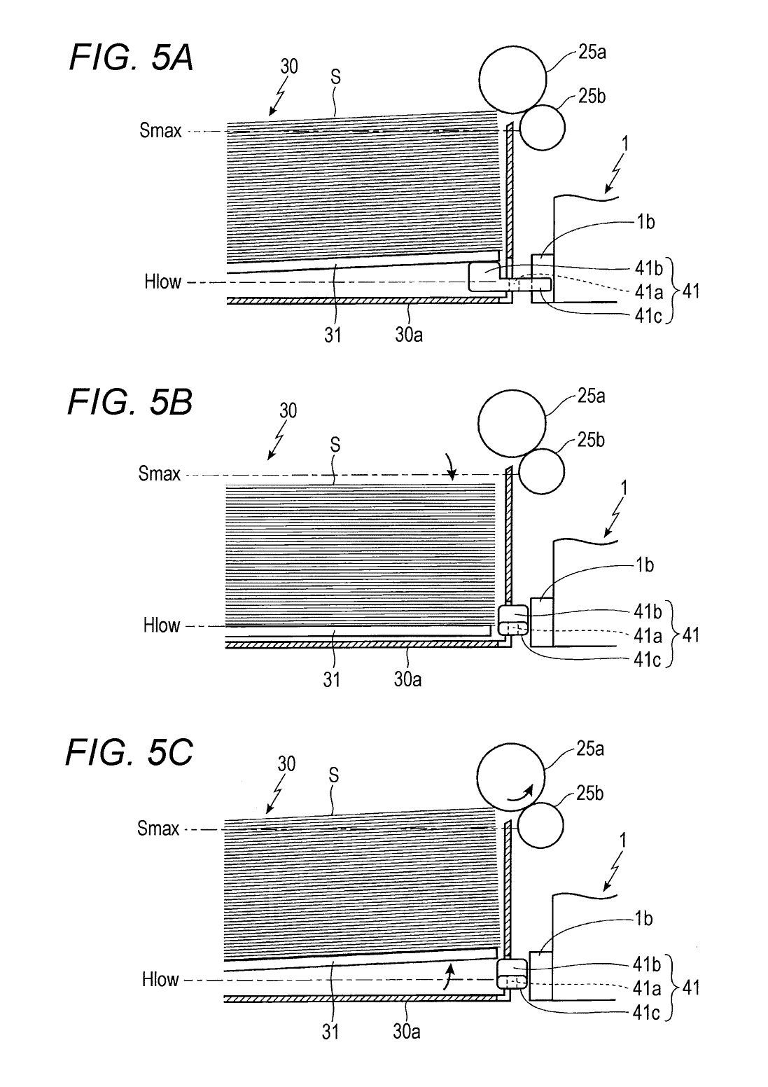

Next, description is made of a case in the first example in which the sheets S are loaded over the allowable maximum loading position Smax on the lifting plate 31 in a state that the lifting plate 31 is moved up by the holding portion 41b in the holding member 41 so that the lifting plate 31 is held at the position higher than the lowest position Hlow as illustrated in FIG. 5A.

Here, upon guiding the paper tray 30 into the apparatus main body 1 in a state that the sheets S are loaded over the allowable maximum loading position Smax on the lifting plate 31 held at the position higher than the lowest position Hlow and rotating the holding member 41 around the shaft 41a resisting against the energizing member as illustrated in FIG. 4C to guide the holding portion 41b that holds the lifting plate 31 to the position away from below the lifting plate 31, the lifting plate 31 that is held by the holding portion 41b at the position higher than the lowest position Hlow is rotated downward using the supporting shaft 31a as a fulcrum as illustrated in FIG. 5B to be guided to the lowest position Hlow and the position of the sheets S set on the lifting plate 31 goes down to be guided to the position lower than the allowable maximum loading position Smax.

As a result, even when the paper tray 30 is guided into the apparatus main body 1 in the state that the sheets S are loaded over the allowable maximum loading position Smax on the lifting plate 31, the lifting plate 31 goes down to the lowest position Hlow and the sheets S set on the lifting plate 31 are guided to the position lower than the allowable maximum loading position Smax. In the occurrence of the impact or the like caused when the paper tray 30 is inserted into the apparatus main body 1, this structure can easily prevent the excess sheets S in the paper tray 30 from going up on the width-direction restricting plate 32a or going out of the paper tray 30.

After the paper tray 30 with the sheets S set on the lifting plate 31 as above is guided to a predetermined position in the apparatus main body 1, the lifting plate 31 is rotated upward by a rotating member such as a spring using the supporting shaft 31a as a fulcrum to bring the uppermost sheet S on the lifting plate 31 in contact with the paper feeding roller 25a as illustrated in FIG. 5C, so that the uppermost sheet S on the lifting plate 31 is fed. Even if the sheets S are set over the allowable maximum loading position Smax as above, this process enables the excess sheets S to be fed properly from the lifting plate 31 by the paper feeding roller 25a.

Next, a second example of the above embodiment will be described. In the second example, when the paper tray 30 is pulled out of the apparatus main body 1 and the sheets S are loaded on the lifting plate 31 in the paper tray 30, the lifting plate 31 is held by the holder at the position higher than the lowest position Hlow, and before the operation of inserting the paper tray 30 into the apparatus main body 1 is completed, the holding by the holder is canceled so that the lifting plate 31 goes down to the lowest position Hlow.

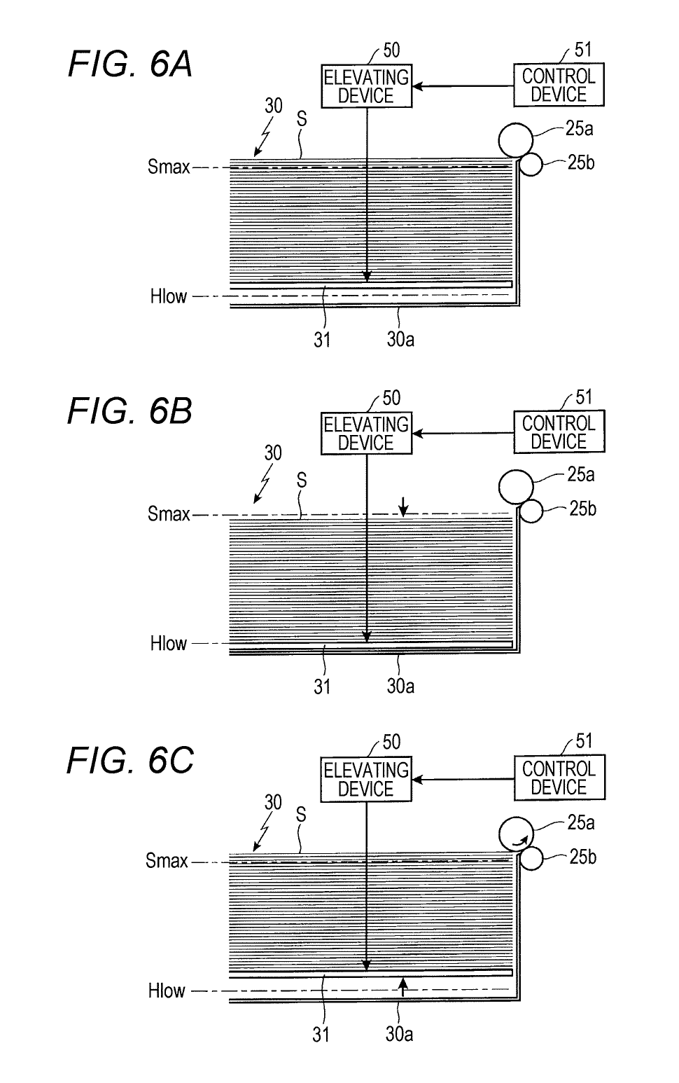

In the second example, an elevating device 50 that moves up and down the lifting plate 31 in the vertical direction in the paper tray 30 is provided as illustrated in FIGS. 6A to 6C, and a control device 51 that controls the stop position of the lifting plate 31 by moving up and down the lifting plate 31 by the elevating device 50 is provided as the holder that stops the lifting plate 31 at a position higher than the lowest position Hlow when the paper tray 30 is pulled out of the apparatus main body 1 and the sheets S are loaded.

In the second example, when the paper tray 30 is pulled out of the apparatus main body 1 and the sheets S are loaded, the control device 51 controls the elevating device 50 as illustrated in FIG. 6A to stop and hold the lifting plate 31 at the position higher than the lowest position Hlow and in this state, the sheets S are loaded on the lifting plate 31. In the second example, the sheets S are set over the allowable maximum loading position Smax on the lifting plate 31 that is held at the position higher than the lowest position Hlow, and in this point, the second example is similar to the first example.

In order to guide the paper tray 30 into the apparatus main body 1 in the state that the sheets S are set over the allowable maximum loading position Smax on the lifting plate 31 stopped at the position higher than the lowest position Hlow, the following process is performed: the control device 51 controls the elevating device 50 to gradually lower the lifting plate 31 so that the lifting plate 31 goes down to the lowest position Hlow as illustrated in FIG. 6B before the operation of guiding the paper tray 30 to the predetermined position in the apparatus main body 1 is completed. Such a process enables the sheets S set on the lifting plate 31 to be guided to the position lower than the allowable maximum loading position Smax.

Even when the paper tray 30 is guided into the apparatus main body 1 in the state that the sheets S are set over the allowable maximum loading position Smax on the lifting plate 31, which is similar to the first example, the lifting plate 31 goes down to the lowest position Hlow and the sheets S set on the lifting plate 31 are guided to the position lower than the allowable maximum loading position Smax. Even in the occurrence of the impact or the like caused when the paper tray 30 is inserted into the apparatus main body 1, this structure can easily prevent the excess sheets S in the paper tray 30 from going up on the width-direction restricting plate 32a or going out of the paper tray 30.

After the paper tray 30 with the sheets S set on the lifting plate 31 as above is guided to the predetermined position in the apparatus main body 1, the control device 51 controls the elevating device 50 to move up the lifting plate 31 so that the uppermost sheet S on the lifting plate 31 is brought into contact with the paper feeding roller 25a as illustrated in FIG. 6C and the uppermost sheet S on the lifting plate 31 is fed. Thus, even when the paper tray 30 is guided into the apparatus main body 1 in the state that the sheets S are loaded over the allowable maximum loading position Smax on the lifting plate 31, it is possible to prevent the excess sheets S in the paper tray 30 from going up on the width-direction restricting plate 32a or going out of the paper tray 30 and the proper paper feeding can be performed.

In the second example, when the lifting plate 31 is moved up and down by the elevating device 50, the control device 51 controls the position where the lifting plate 31 stops, and stops and holds the lifting plate 31 at the position higher than the lowest position Hlow before the paper tray 30 is guided into the apparatus main body 1. However, as described in the first example, the holding member 41 that rotates in parallel to the bottom part 30a of the paper tray 30 around the shaft 41a in the lower part of the paper tray 30 may be provided. By rotating this holding member 41 to control the position to stop the lifting plate 31, the holding portion 41b with the large thickness in the holding member 41 can be guided to the position between the lifting plate 31 and the bottom part 30a of the paper tray 30, so that the lifting plate 31 can be stopped and held at the position higher than the lowest position Hlow.

Next, a third example of the above embodiment will be described. In the third example, when the paper tray 30 is pulled out of the apparatus main body 1 and the sheets S are loaded on the lifting plate 31 in the paper tray 30, the lifting plate 31 is held by the holder at the position higher than the lowest position Hlow, and before the operation of inserting the paper tray 30 into the apparatus main body 1 is completed, the holding by the holder is canceled so that the lifting plate 31 goes down to the lowest position Hlow.

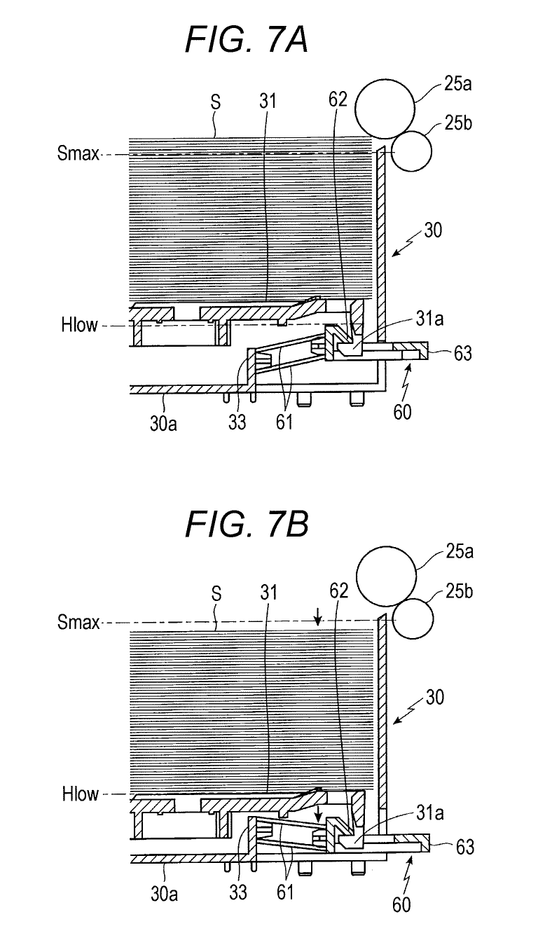

Here, in the third example, an engagement portion 31b, which is bent to have a hook-like shape, is provided to extend downward at an end of the lifting plate 31 on the paper feeding roller 25a side as illustrated in FIGS. 7A and 7B, and the like. In addition, a compression coil spring 61 is provided in a state of being able to tilt in the vertical direction to an attachment portion 33 in the lower part of the paper tray 30 on the paper feeding roller 25a side so that the compression coil spring 61 faces the apparatus main body 1 side. Moreover, an adjustment member 60 is provided to protrude from the paper tray 30 to the inside of the apparatus main body 1. The adjustment member 60 is movable in the vertical direction and forward and backward in the paper feeding direction through this compression coil spring 61. This adjustment member 60 is provided with an engagement portion 62 with which the engagement portion 31b of the lifting plate 31 is engaged. An end of the adjustment member 60 that protrudes to the inside of the apparatus main body 1 is provided with a tilted portion 63 that is tilted so that the protruding length of the tilted portion 63 decreases along the direction where the paper tray 30 is inserted.

In the third example, when the paper tray 30 is pulled out of the apparatus main body 1 and the sheets S are loaded in the paper tray 30, as illustrated in FIG. 7A, the compression coil spring 61 attached to the attachment portion 33 in the lower part of the paper tray 30 on the paper feeding roller 25a side is tilted upward to the apparatus main body 1 side to make the adjustment member 60 exist in the upper part. In this state, the engagement portion 31b of the lifting plate 31 is engaged with the engagement portion 62 of the adjustment member 60 so that the lifting plate 31 is held at the position higher than the lowest position Hlow, and the sheets S are loaded on this lifting plate 31. Thus, the sheets S are set over the allowable maximum loading position Smax.

On the other hand, in this third example, before the operation of inserting the paper tray 30 containing the sheets S over the allowable maximum loading position Smax into the apparatus main body 1 is completed, as illustrated in FIG. 7B, the compression coil spring 61 attached to the attachment portion 33 in the lower part of the paper tray 30 on the paper feeding roller 25a side is tilted downward to the apparatus main body 1 side so as to move the adjustment member 60 downward and moreover, the lifting plate 31 having the engagement portion 31b engaged with the engagement portion 62 of the adjustment member 60 is moved down to the lowest position Hlow so that the sheets S loaded on the lifting plate 31 are guided to the position lower than the allowable maximum loading position Smax.

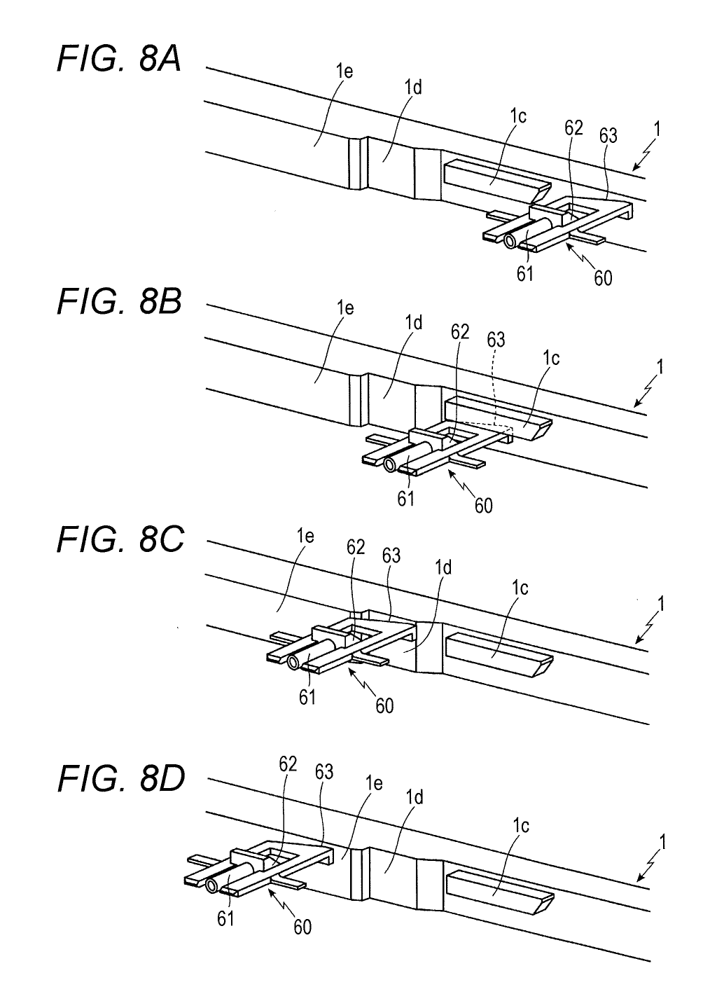

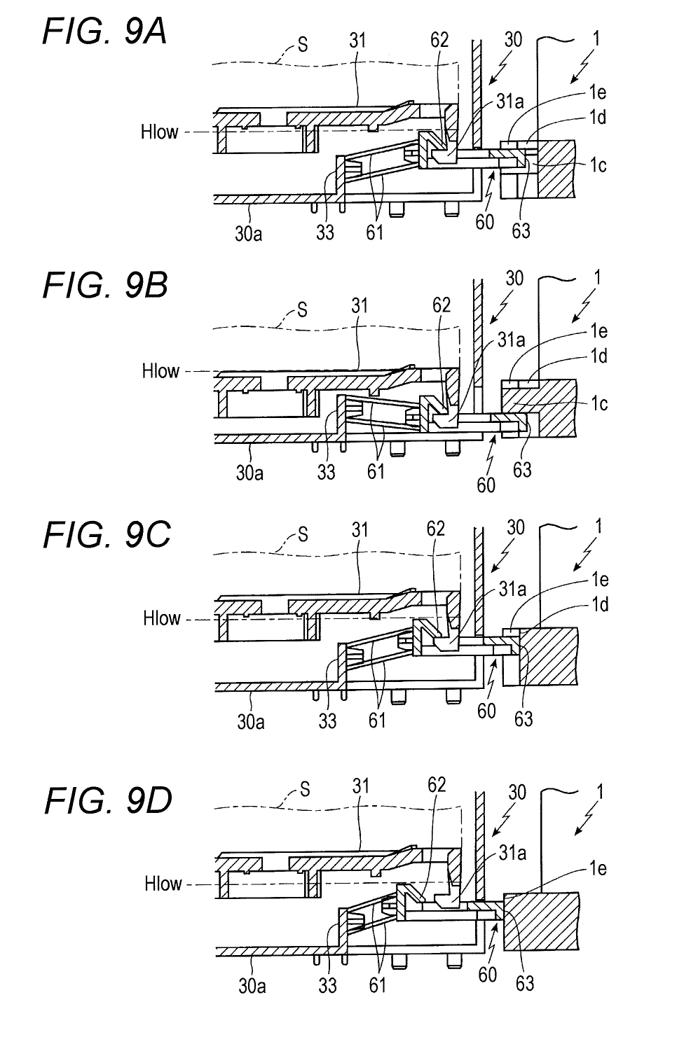

In the third example, as illustrated in FIGS. 8A to 8D and FIGS. 9A to 9D, in order to move down the lifting plate 31 to the lowest position Hlow so that the sheets S loaded on the lifting plate 31 are guided to the position lower than the allowable maximum loading position Smax before the operation of inserting the paper tray 30 containing the sheets S over the allowable maximum loading position Smax into the apparatus main body 1 is completed, the following lowering projection 1c, first pressing protrusion 1d, and second pressing protrusion 1e are used. The lowering projection 1c, the first pressing protrusion 1d, and the second pressing protrusion 1e are provided in the apparatus main body 1 to face the paper tray 30 on the paper feeding roller 25a side in a portion on the insertion side where the paper tray 30 is inserted into the apparatus main body 1. The lowering projection 1c has predetermined length in the inserting direction of the paper tray 30 and presses down the adjustment member 60 positioned in the upper part as described above. The first pressing protrusion 1d is provided on the downstream side relative to the lowering projection 1c in the inserting direction of the paper tray 30 into the apparatus main body 1, and presses the adjustment member 60 toward the paper tray 30. The second pressing protrusion 1e is provided on the downstream side relative to the first pressing protrusion 1d in the inserting direction of the paper tray 30 into the apparatus main body 1, and presses the adjustment member 60 further to the paper tray 30.

Here, when the paper tray 30 is inserted into the apparatus main body 1, the lifting plate 31 is continuously held at the position higher than the lowest position Hlow until the adjustment member 60 is guided to the lowering projection 1c as illustrated in FIGS. 8A and 9A.

Then, when the paper tray 30 is inserted into the apparatus main body 1 and the adjustment member 60 is guided to the position of the lowering projection 1c as illustrated in FIGS. 8B and 9B, the adjustment member 60 positioned in the upper part as described above is pressed down by the lowering projection 1c. This causes the lifting plate 31, which has the engagement portion 31b engaged with the engagement portion 62 of the adjustment member 60, to go down and the lifting plate 31 is guided to the lowest position Hlow. Thus, the sheets S loaded on the lifting plate 31 are guided to the position lower than the allowable maximum loading position Smax.

Next, the paper tray 30 is further inserted in the apparatus main body 1 and the adjustment member 60 is guided to the position of the first pressing protrusion 1d on the downstream side in the inserting direction over the lowering projection 1c as illustrated in FIGS. 8C and 9C. This movement causes the lifting plate 31 in the low position to go up gradually, and the adjustment member 60 in the state of being pressed toward the apparatus main body 1 by the compression coil spring 61 is pressed to the paper tray 30 side by the first pressing protrusion 1d, so that the compression coil spring 61 is compressed. Then, in a state that the engagement portion 31b of the lifting plate 31 is engaged with the engagement portion 62 of the adjustment member 60, the engagement portion 62 of the adjustment member 60 is moved in a direction away from the apparatus main body 1.

In addition, when the paper tray 30 is inserted into the apparatus main body 1 and the adjustment member 60 is guided to a predetermined position in the apparatus main body 1 by the second pressing protrusion 1e on the downstream side relative to the first pressing protrusion 1d in the inserting direction as illustrated in FIGS. 8D and 9D, the adjustment member 60 in the state of being pressed by the compression coil spring 61 toward the apparatus main body 1 is pressed by the second pressing protrusion 1e further to the paper tray 30 and the compression coil spring 61 is further compressed, so that the engagement portion 31b of the lifting plate 31 is disengaged from the engagement portion 62 of the adjustment member 60.

After that, in a manner similar to the first example, the lifting plate 31 is rotated upward by a rotation member such as a spring using the supporting shaft 31a as a fulcrum, thereby bringing the sheets S loaded on the lifting plate 31 in contact with the paper feeding roller 25a. Then, the uppermost sheet S on the lifting plate 31 in contact with the paper feeding roller 25a is fed.

Thus, even when the paper tray 30 is guided into the apparatus main body 1 in the state that the sheets S are set over the allowable maximum loading position Smax on the lifting plate 31, which is similar to the first and second examples, it is possible to prevent the excess sheets S from going up on the width-direction restricting plate 32a in the paper tray 30 or going out of the paper tray 30 and the paper feeding roller 25a can perform the proper feeding.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image formation apparatus having a paper tray which is removably provided to an apparatus main body, in which sheets are loaded on a lifting plate, and from which the sheets on the lifting plate are fed by a paper feeding device, the apparatus comprising a holder that holds the lifting plate at a position higher than a lowest position when the paper tray is pulled out of the apparatus main body and the sheets are loaded on the lifting plate, wherein the holding by the holder is canceled to make the lifting plate go down to the lowest position before an operation of inserting the paper tray into the apparatus main body is completed.

2. The image formation apparatus according to claim 1, wherein the holder includes a holding member provided to be able to advance or retract between the lifting plate and a bottom part of the paper tray.

3. The image formation apparatus according to claim 2, wherein the holding member is provided to the paper tray.

4. The image formation apparatus according to claim 2, wherein a canceller that cancels the holding of the lifting plate by the holding member by having the holding member advance or retract between the lifting plate and the bottom part of the paper tray is provided to the apparatus main body.

5. The image formation apparatus according to claim 4, wherein the canceller includes a protrusion provided to protrude in the apparatus main body and the holding member in a state of being positioned between the lifting plate and the bottom part of the paper tray is separated from the position between the lifting plate and the bottom part of the paper tray by being pushed by the protrusion as the paper tray is inserted into the apparatus main body.

6. The image formation apparatus according to claim 1, further comprising an elevating device for moving the lifting plate in a vertical direction, and a control device as the holder that controls the elevating device so that the lifting plate is stopped at a position higher than the lowest position when the paper tray is pulled out of the apparatus main body and the sheets are loaded.

7. The image formation apparatus according to claim 1, wherein when the paper tray is pulled out of the apparatus main body and the sheets are loaded on the lifting plate, the holder holds the lifting plate at the position higher than the lowest position and lower than an uppermost position.
